(19) United States
(12) Patent Application Publication
(10) Pub. No.: US 2018/0270145 A1
(43) Pub. Date: Sep. 20, 2018

(54) NODE CONNECTION METHOD AND DISTRIBUTED COMPUTING SYSTEM

(71) Applicant: WANGSU SCIENCE & TECHNOLOGY CO.,LTD., Shanghai (CN)

(72) Inventors: Qiuzhong CHEN, Shanghai (CN); Huaming LIU, Shanghai (CN)

(21) Appl. No.: 15/548,048

(22) PCT Filed: Mar. 9, 2017
(86) PCT No.: PCT/CN2017/076025

§ 371 Date: Aug. 1, 2017

(30) Foreign Application Priority Data
Nov. 28, 2016 (CN) 201611060923.1

(51) Int. Cl. H04L 12/755; H04L 29/08; G06F 9/455

(52) U.S. Cl. CPC H04L 45/021; H04L 67/1002; G06F 2009/45595; H04L 67/14; G06F 9/45558; H04L 67/28

(57) ABSTRACT

The present disclosure provides a node connection method and a distributed computing system. The distributed computing system comprises a plurality of clients and a plurality of servers. A server comprises a mapping table. The node connection method comprises: recording node information and a mapping relationship between nodes in the mapping table; visiting, by a client, a service side of the distributed computing system based on the node information; acquiring a target node corresponding to the node information in the mapping table; and connecting, by the client, to the target node. The present disclosure may simplify a system structure of the distributed computing system, reduce the system management cost, and improve the working efficiency of the client in the system and the master-slave changing speed in each server.

### FIELD OF THE DISCLOSURE

The present disclosure relates to the field of internet technology and, more particularly, relates to a node connection method and a distributed computing system.

### BACKGROUND

The in-memory database Redis (key-value database) is configured to support master-slave replication, and redis-sentinel (a service of Redis instance monitoring & managing, notification, and instance failover) is officially provided to perform master-slave monitoring and master-slave switching. However, because of the transfer of the master device, the Redis client may fail to be connected to the same ip address all the time. Currently, the known solutions use a method of integrating haproxy (a reverse proxy software)+keepalived (a service software to ensure high availability of the cluster in the cluster management)+sentinel. More specifically, keepalived provides vip (virtual ip) for the client to connect and manage haproxy failover, haproxy determines whether redis is the master device and is directly connected to the master device, and sentinel performs master-slave monitoring and master-slave switching on the redis.

The existing accelerating solution has two drawbacks:

1. The system in the solution is too complicated. Though one group of sentinel and haproxy may perform management on a plurality of Redis master-slave, one keepalived may only have one vip to map one Redis master-slave, and if a plurality of Redis master-slave need to be managed, a plurality of keepalived are needed. Further, if management is only performed on one Redis master-slave, the system cost may be too high.

2. The aforementioned solution results in an issue regarding the performance, and because all connections need to be forwarded via haproxy, for high-speed Redis, extra burden may be generated compared to the long waiting period of time of HAProxy.

### BRIEF SUMMARY OF THE DISCLOSURE

Technical issues to be solved by the present disclosure is to overcome the drawbacks of high cost and low efficiency of master-slave management in the existing distributed computing system. A node connection method and a distributed computing system are provided to reduce the system management cost, and improve the working efficiency of a client in the system as well as the master-slave changing speed of each server.

The present disclosure solves the aforementioned technical issues via the following technical solutions:

A node connection method is provided for a distributed computing system. The distributed computing system comprises a plurality of clients and a plurality of servers, where a server comprises a mapping table. The node connection method comprises:

Recording node information and a mapping relationship between nodes in a mapping table;

Visiting, by a client, a service side of the distributed computing system based on the node information;

Acquiring a target node corresponding to the node information in the mapping table; and

Connecting the client to the target node.

The present disclosure utilizes the mapping table of the server to store a mapping relationship. The node information comprises a node that the client needs to visit, and the node may be a real node or may be a virtual node. The client searches for a corresponding target node in the mapping table based on the node information, and the target node is a real node. That is, when the node recorded in the node information is a virtual node, the client may, based on a real node corresponding to the virtual node in the mapping relationship, visit the real node. The server may be the third party, which is independent of the server used for calculation and storage.

The aforementioned distributed computing system realizes the concept of RedisProxy (Redis agency), and utilizes virtual node to agent real node. One redis cluster may have a plurality of redis nodes, where one master corresponds to a plurality of slaves. If a Redis cluster is treated as a virtual Redis node, when the RedisClient is connected to the redis server, whether the redis server is a cluster or a single instance may no longer need to be considered, which is friendly for the RedisClient.

Preferably, the node connection method comprises:

Determining whether master-slave change exists in the distributed computing system, and if master-slave change exists in the distributed computing system, updating the mapping relationship between the nodes after change in the mapping table; and

Acquiring the target node corresponding to the node information via a latest mapping table.

The disclosed system may monitor the change in master-slave, and when a machine fault exists or a new machine is added, the system may make a response rapidly, thereby improving the working efficiency of the client in the system and the changing speed of master-slave in each server.

Preferably, the node includes a real node and a virtual node. The master-slave change includes adding a master-slave and master-slave switching in the distributed computing system. Further, determining whether a master-slave change exists in the distributed computing system comprises:

Determining whether the master-slave change is master-slave switching, and if the master-slave change is master-slave switching, switching a master node mapped to the virtual node to a previous slave node in the mapping table; or

Determining whether the master-slave change is adding a master-slave, and if the master-slave change is adding a master-slave, adding a node mapping relationship of a newly added master-slave in the mapping table;

Where the master node and the slave node are both real instances.

According to the present disclosure, master-slave switching refers to, after a fault downtime occurs at a master, a slave continues the master's work to allow the system to continue providing normal services. When such situation occurs, the mapping relationship in the mapping table changes, and the mapping table needs to replace the master node encountering an issue that corresponds to the virtual node with a slave node. After the client monitors a change in the mapping table, an updated slave node is connected.

Adding a master-slave refers to adding a new server in the original system, and when such situation occurs, the virtual node may be allocated to a real node in the newly added server, and the mapping relationship in the mapping table may also change. After the client monitors a change in the mapping table, an updated slave node is connected.

Monitoring of the master-slave may be realized via sentinel, and after the master-slave changes, the mapping table also changes. The client may determine whether the mapping table changes or not, and after the mapping relationship is determined to have changed, the client is connected to the latest accurate real node.

Preferably, acquiring the real node corresponding to the node information in the mapping table comprises:

Visiting, by the client, the mapping table; and

Determining, by the client, whether a to-be-visited node is a virtual node based on the node information, and if the to-be-visited node is a virtual node, acquiring and visiting a real node corresponding to the to-be-visited node in the mapping table, otherwise directly visiting the to-be-visited node.

Preferably, the node connection method further comprises:

After the client visits the real node, determining whether the visited real node changes or not by detecting the mapping table, and if the visited real node changes, the client is re-connected to the real node after change.

Preferably, the node information comprises information of a host name and a port number, and the client recognizes the to-be-visited node based on a naming rule of the host name and the port number.

The node name may be a combination of the host name and the port, such as host001:1, host001:2, and host002:1. The rule can be defined as follows: host01 may be virtual, host001 may be real (i.e., two digits may indicate a virtual redis host name), the master node is host001:1, and the slave node is host002:1.

Preferably, the distributed system comprises a sentinel terminal configured to monitor the master-slave change, the mapping table is recorded in zookeeper, and the node connection method comprises:

Determining, by the sentinel terminal, whether a master-slave change occurs, and if the master-slave change occurs, writing the mapping relationship after change into zookeeper via a notification script.

The present disclosure further provides a distributed computing system. The distributed computing system comprises a plurality of clients and a plurality of servers. A server comprises a mapping table, and the server further comprises a recording module. A client comprises a visiting module, an acquiring module, and a connecting module.

The recording module is configured to record node information and a mapping relationship between nodes in the mapping table;

The visiting module is configured to visit a service side of the distributed computing system based on the node information;

The acquiring module is configured to acquire a target node corresponding to the node information in the mapping table; and

The connecting module is configured to connect the target node.

Preferably, the server further comprises a determining module and an updating module.

The determining module is configured to determine whether a master-slave change exists in the distributed computing system, and if a master-slave change exists in the distributed computing system, the updating module is invoked;

The updating module is configured to update the mapping relationship between nodes after change to the mapping table; and

The acquiring module is configured to acquire the target node corresponding to the node information via a latest mapping table.

Preferably, the node includes a real node and a virtual node. The master-slave change includes adding a master-slave and master-slave switching in the distributed computing system. Further, the server further comprises a processing module.

The determining module is further configured to determine whether the master-slave change is master-slave switching, and if the master-slave change is master-slave switching, the processing module is invoked; and

The processing module is configured to switch a node that is mapped to the virtual node to a previous slave node in the mapping table.

Or, the determining module is further configured to determine whether the master-slave change is adding a master-slave, and if the master-slave change is adding a master-slave, the processing module is invoked; and

The processing module is configured to add a node mapping relationship of the newly added master-slave in the mapping table;

Where the master node and the slave node are both real instances.

Preferably, the client comprises a recognizing module.

The recognizing module is configured to, after the client visits the mapping table, determine whether the to-be-visited node is a virtual node or not based on the node information. If the to-be-visited node is a virtual node, the recognizing module is configured to invoke the acquiring module to acquire and visit the real node corresponding to the to-be-visited node in the mapping table. If the to-be-visited node is not a virtual node, the recognizing module is configured to invoke the connecting module to directly visit the to-be-visited node.

Preferably, the client comprises a detecting module.

The detecting module is configured to, after the client visits the real node, determine whether the real node changes or not by detecting the mapping table, and if the real node changes, the client is re-connected to the real node after change.

The active and progressive effects of the present disclosure lie in that: the present disclosure may simplify the method of connecting the redis client to the redis server in the distributed computing system, reduce the system arrangement cost, and improve the performance of connection between the redis client and the redis server.

More specifically, the disclosed system and method no longer need to use the existing, conventional, and complicated keepalived and haproxy system, and a method of only sentinel and zookeeper may be used. The sentinel performs the same master-slave switching to write the master information into zookeeper via the notification script of the sentinel. Accordingly, not only the usage cost of the system may be reduced, but the efficiency may be improved.

### BRIEF DESCRIPTION OF THE DRAWINGS

To more clearly illustrate technical solutions in embodiments of the present disclosure, the accompanying drawings used for describing the embodiments are briefly introduced hereinafter. Obviously, the accompanying drawings in the following descriptions are only some embodiments of the present disclosure, and for those ordinarily skilled in the relevant art, other drawings may be obtained according to the accompanying drawings without creative labor.

FIG. 1 illustrates a partial schematic view of a distributed computing system according Embodiment 1;

FIG. 2 illustrates a flow chart of a node connection method according to Embodiment 1; and

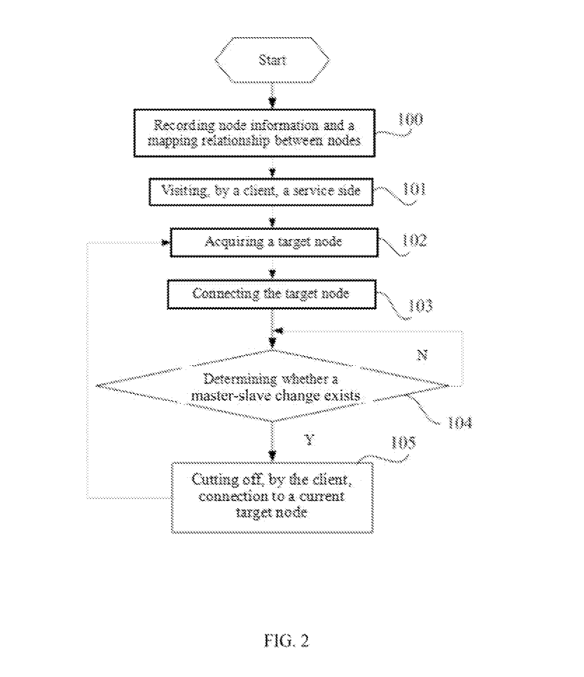

FIG. 3 illustrates a flow chart of a node connection method according to Embodiment 3.

### DETAILED DESCRIPTION

To make the object, technical solutions and advantages of the present disclosure more apparent, technical solutions in embodiments of the present disclosure will be described completely and fully hereinafter with reference to the accompanying drawings in embodiments of the present disclosure. Obviously, the described embodiments are a part of embodiments of the present disclosure, but not all embodiments. Based on the embodiments of the present disclosure, all other embodiments obtainable by those ordinarily skilled in the relevant art without contributing creative labor shall all fall within the protection range of the present disclosure.

### Embodiment 1

The present disclosure provides a distributed computing system. The distributed computing system comprises a plurality of clients and a plurality of servers. A server comprises a mapping table, and the mapping table is recorded in zookeeper of the server. The server further comprises a recording module, and a client comprises a visiting module, an acquiring module, a recognizing module, a detecting module, and a connecting module.

The recording module is configured to record node information and a mapping relationship between nodes in the mapping table.

The visiting module is configured to visit a service side of the distributed computing system based on the node information, and the node recorded in the node information may be a virtual node or may be a real node.

The recognizing module is configured to, after the client visits the mapping table, determine whether a to-be-visited node is a virtual node or not based on the node information. If the to-be-visited node is a virtual node, the acquiring module is invoked to acquire a real node corresponding to the to-be-visited node in the mapping table. if the to-be-visited node is not a virtual node, the connecting module is invoked to directly visit the to-be-visited node.

The connecting module is configured to visit the real node, and when the node in the node information is a virtual node, the real node (i.e., a target node) is acquired based on the mapping table. When the node in the node information is a real node, the connecting module is directly connected to the target node.

The node information comprises information of a host name and a port number, and the client may recognize the to-be-visited node based on a naming rule of the host name and the port number.

The node name in the node information may be a combination of the host name and the port, such as host001:1, host001:2, and host002:1. The rule can be defined as follows: host01 may be virtual, host001 may be real (i.e., two digits may indicate a virtual redis host name), the master node is host001:1, and the slave node is host002:1.

Via the node name, whether the node included in the node information is a real node or a virtual node may be determined.

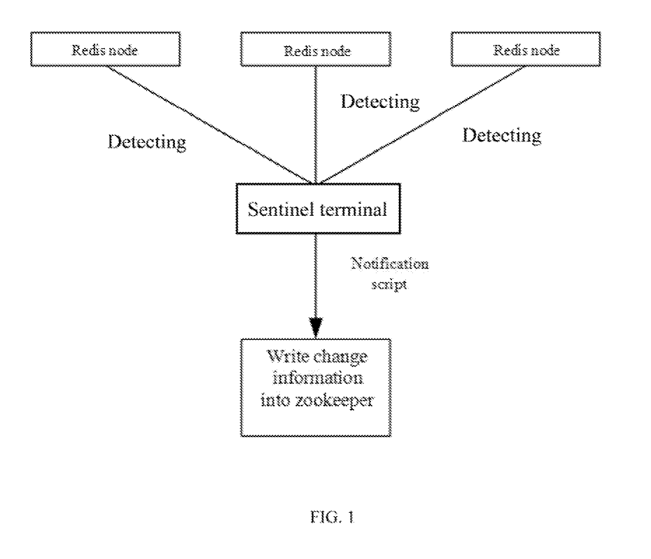

Referring to FIG. 1, in one embodiment, the server has a sentinel function. That is, the server comprises a sentinel terminal configured to monitor the master-slave change, and the sentinel terminal comprises a determining module and a processing module.

The determining module is configured to determine whether master-slave switching exists in the distributed computing system, and if master-slave switching exists in the distributed computing system, the processing module is invoked.

The processing module is configured to, in the mapping table, switch the node that is mapped to the virtual node to a previous slave node. After the master goes down, the virtual node needs to correspond to the node in the slave.

Further, the master node and the slave node may be both real instances.

The sentinel terminal writes the corresponding relationship into zookeeper via the notification script.

The detecting module is configured to, after the client visits the real node, determine whether the real node changes or not by detecting the mapping table of zookeeper, and if the real node changes, the client is re-connected to the real node after change.

By utilizing the aforementioned distributed computing system, the present disclosure further provides a node connection method, and the node connection method comprises:

Step 100, recording node information and a mapping relationship between nodes in the mapping table.

The node information comprises information of a host name and a port number, and the client may recognize a to-be-visited node based on a naming rule of the host name and the port number.

The node name in the node information may be a combination of the host name and the port, such as host001:1, host001:2, and host002:1. The rule can be defined as follows: the host01 may be virtual, the host001 may be real (i.e., two digits may indicate a virtual redis host name), the master node is host001:1, and the slave node is host002:1.

Step 101, visiting, by the client, a service side of the distributed computing system based on the node information.

Step 102, acquiring a target node corresponding to the node information in the mapping table.

Step 103, connecting the client to the target node.

The client may determine whether the visited node is a real node or a virtual node based on the node information. The client visits the mapping table, and if the visited node is a virtual node, the client may acquire and visit the real node corresponding to the to-be-visited node in the mapping table, and if the visited node is a real node, the client may directly visit the to-be-visited node.

Step 104, detecting, by the client, Zookeeper at the service side to determine whether a master-slave change exists. If the master-slave change exists, Step 105 is executed, and if the master-slave change does not exist, Step 104 is once again executed.

Step 105, cutting off, by the client, connection to a current target node, and returning to Step 102.

The master-slave change comprises master-slave switching and adding a master-slave. When the master-slave switches, the disclosed method switches, in the mapping table, the node that is mapped to the virtual node to a previous slave node. That is, after the master goes down, the virtual node needs to correspond to the node in the slave.

When a new master-slave is added, the disclosed method adds a node mapping relationship of the newly added master-slave in the mapping table, and the client may be connected to the updated node based on the node information and the new mapping table.

The client notices whether the visited real node changes or not by detecting the mapping table, and if the visited real node changes, the client is re-connected to the real node after change.

The disclosed node connection method and distributed computing system may simplify the system structure of the distributed computing system, reduce the system management cost, and improve the client working efficiency in the system and the master-slave changing speed in each server.

### Embodiment 2

Embodiment 2 is similar to Embodiment 1, and the difference lies in that:

The determining module is configured to determine whether a newly added master-slave exists in the distributed computing system, and if a newly added master-slave exists in the distributed computing system, the processing module is invoked; and

The processing module is configured to add the node mapping relationship of the newly added master-slave in the mapping table.

By utilizing the aforementioned distributed computing system, the disclosed node connection method differs from Embodiment 1 in that:

Determining whether the master-slave change is adding a master-slave, and if the master-slave change is adding a master-slave, adding the node mapping relationship of the newly added master-slave in the mapping table;

Where the master node and the slave node are both real instances.

The disclosed node connection method and distributed computing system may simplify the system structure of the distributed computing system, reduce the system management cost, and improve the client working efficiency in the system and the master-slave changing speed in each server.

### Embodiment 3

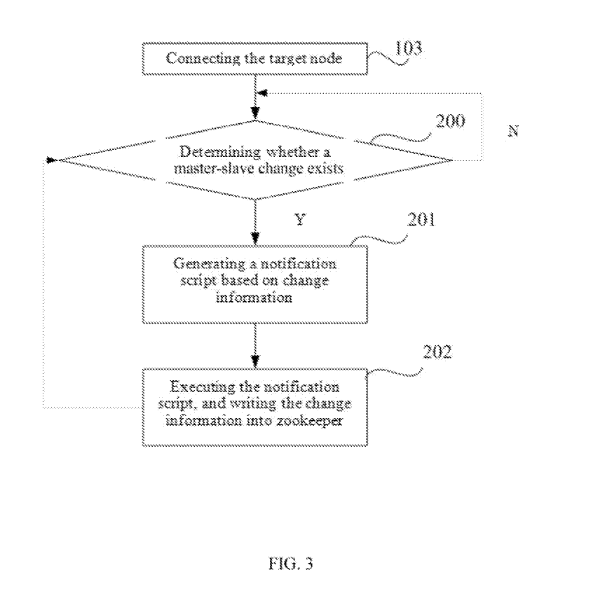

Referring to FIG. 3, the disclosed embodiment is similar to Embodiment 1, where the difference lies in that:

After Step 103, the following steps are included:

Step 200, monitoring, by sentinel, whether a master-slave change exists in the distributed computing system, if a master-slave change exists in the distributed computing system, Step 201 is executed, and if a master-slave change does not exist in the distributed computing system, Step 200 is once again executed.

Step 201, generating a notification script based on change information.

Step 202, executing the notification script, writing the change information into zookeeper, and once again executing Step 200.

Embodiment 3 is further optimized based on Embodiment 1, and when the master-slave change occurs, the client cuts off the current connection and is connected to the newest node based on the mapping table. On the other hand, the service side may update the information of the master-slave change and write the change information into zookeeper.

The device embodiments described above are for illustrative purposes only, and the units illustrated as separate parts may be or may not be physically separated. The parts illustrated as units may be or may not be physical units. That is, the parts may be located in a same place, or distributed to a plurality of network units. A part of or all modules thereof may be selected to realize the object of solutions of the present disclosure based on the actual demand. Those ordinarily skilled in the relevant art may understand and implement the present disclosure without contributing creative labor.

Via the descriptions of the aforementioned embodiments, those skilled in the relevant art may clearly understand that each embodiment may be implemented using software and an essential universal hardware platform, or via the hardware. Based on such understanding, the nature of the aforementioned technical solutions or the part of the aforementioned technical solutions that contributes to the existing technique may be embodied in a form of software products. Such computer software product may be stored in a computer readable storage medium, such as ROM/RAM, magnetic disc, and optical disc, etc., that comprises a plurality of commands configured to allow a computing device (e.g., a personal computer, a server, or a network device, etc.) to execute each embodiment or methods described in some parts of the embodiments.

Lastly, it should be illustrated that, the aforementioned embodiments are only used to illustrate technical solutions of the present disclosure, but not limiting the present disclosure. Though the present disclosure is illustrated in detail with reference to the aforementioned embodiments, those ordinarily skilled in the relevant art should understand that, technical solutions described in each aforementioned embodiment may still be modified, or partial technical characteristics therein may be equivalently replaced. Such modification or alteration do not depart the nature of the related technical solutions from spirit and scope of technical solution in each embodiment of the present disclosure.

What is claimed is:

1. A node connection method applied to a distributed computing system, the distributed computing system comprising a plurality of clients and a plurality of servers, wherein a server comprises a mapping table, and the node connection method comprises:
recording node information and a mapping relationship between nodes in the mapping table;
visiting, by a client, a service side of the distributed computing system based on the node information;
acquiring a target node corresponding to the node information in the mapping table; and
connecting, by the client, to the target node.

2. The node connection method according to claim 1, further comprising:
determining whether a master-slave change exists in the distributed computing system, when the master-slave change exists, updating a mapping relationship between nodes after change to the mapping table; and
acquiring the target node corresponding to the node information through a latest mapping table.

3. The node connection method according to claim 2, wherein the nodes includes a real node and a virtual node, the master-slave change includes adding a group of master-slave and master-slave switching in the distributed computing system, and determining whether the master-slave change exists in the distributed computing system comprises:
determining whether the master-slave change is master-slave switching, and when the master-slave change is the master-slave switching, switching, in the mapping table, a master node that is mapped to the virtual node to a previous slave node; or
determining whether the master-slave change is adding a group of master-slave, and when the master-slave change is adding the group of master-slave, adding a node mapping relationship of the newly added group of master-slave in the mapping table,
wherein the master node and the slave node are both real instances.

4. The node connection method according to claim 1, wherein acquiring the real node corresponding to the node information in the mapping table further comprises:
visiting, by the client, the mapping table; and
determining, by the client, whether a to-be-visited node is a virtual node based on the node information, when the to-be-visited node is a virtual node, acquiring and visiting a real node corresponding to the to-be-visited node in the mapping table, and when the to-be-visited node is not a virtual node, visiting the to-be-visited node directly.

5. The node connection method according to claim 4, further comprising:
after visiting the real node, determining, by the client, whether the visited real node is changed or not by detecting the mapping table, and when the visited real node is changed, re-connecting to the real node after change.

6. The node connection method according to claim 1, wherein the node information comprises information of a host name and a port number, and the client recognizes the to-be-visited node based on a naming rule of the host name and the port number.

7. The node connection method according to claim 1, wherein the distributed computing system comprises a sentinel terminal configured to monitor a master-slave change, the mapping table is recorded in zookeeper, and the node connection method comprises:
determining, by the sentinel terminal, whether the master-slave change occurs, and when the master-slave change occurs, writing a mapping relationship after change to zookeeper via a notification script.

8. A distributed computing system, comprising a plurality of clients and a plurality of servers, wherein a server includes a mapping table, the server further includes a recording module, and a client includes a visiting module, an acquiring module, and a connecting module,
the recording module is configured to record node information and a mapping relationship between nodes in the mapping table;
the visiting module is configured to visit a service side of the distributed computing system based on the node information;
the acquiring module is configured to acquire a target node corresponding to the node information in the mapping table; and
the connecting module is configured to connect to the target node.

9. The distributed computing system according to claim 8, wherein the server further comprises a determining module and an updating module,
the determining module is configured to determine whether a master-slave change exists in the distributed computing system, and when the master-slave change exists in the distributed computing system, the updating module is invoked;
the updating module is configured to update a mapping relationship between nodes after change to the mapping table; and
the acquiring module is configured to acquire the target node corresponding to the node information via a latest mapping table.

10. The distributed computing system according to claim 9, wherein the nodes includes a real node and a virtual node, the master-slave change includes adding a group of master-slave and master-slave switching in the distributed computing system, and the server further comprises a processing module,
the determining module is further configured to determine whether the master-slave change is the master-slave switching or not, and when the master-slave change is the master-slave switching, the processing module is invoked; and
the processing module is configured to switch, in the mapping table, a node that is mapped to the virtual node to a previous slave node,
or,
the determining module is further configured to determine whether the master-slave change is adding the group of master-slave, and when the master-slave change is adding the group of master-slave, the processing module is invoked; and
the processing module is configured to add a node mapping relationship of a newly added group of master-slave in the mapping table,
wherein the master node and the slave node are both real instances.

11. The distributed computing system according to claim 8, wherein the client comprises a recognizing module,
the recognizing module is configured to, after the client visited the mapping table, determine whether a to-be-visited node is a virtual node or not based on the node information, when the to-be-visited node is a virtual node, the acquiring module is invoked to acquire and visit a real node corresponding to the to-be-visited node in the mapping table, and when the to-be-visited node is not a virtual node, the connecting module is invoked to visit the to-be-visited node directly.

12. The distributed computing system according to claim 11, wherein the client comprises a detecting module,
the detecting module is configured to, after the client connects to the real node, determine whether the real node changes or not by detecting the mapping table, and when the real node changes, re-connecting the real node after change.
